(19) United States
(12) Patent Application Publication
(10) Pub. No.: US 2008/0231740 A1
(43) Pub. Date: Sep. 25, 2008

(54) CAMERA WITH MULTIPLE DISPLAYS

(76) Inventors: Dale F. McIntyre, Honeoye Falls, NY (US); Kenneth A. Parulski, Rochester, NY (US); Jerald J. Muszak, Henrietta, NY (US)

Correspondence Address: Frank Pincelli;Patent Legal Staff, Eastman Kodak Company, 343 State Street, Rochester, NY, 14650-2201, US

(21) Appl. No.: 11/688,910

(22) Filed: Mar. 21, 2007

(51) Int. Cl. H04N 5/222

(52) U.S. Cl. 348/333.01; 348/E05.024

(57) ABSTRACT

The present disclosure relates to a digital camera including a first image display formed on the surface of the camera body. The digital camera also includes a second image display mounted to the camera body and deployable to at least one viewing position in which the first and second image displays provide a combined display area.

### CROSS REFERENCE TO RELATED APPLICATIONS

Reference is made to commonly assigned U.S. patent application Ser. No. ______ filed Mar. 21, 2007 (docket 93599A) entitled “Camera with Multiple Displays” by Dale F. McIntyre et al., the disclosure of which is incorporated herein by reference.

### FIELD OF THE INVENTION

This invention generally relates to photography and photographic equipment and more particularly relates to a digital camera that provides a combined display area formed by two or more image displays.

### BACKGROUND OF THE INVENTION

Conventional digital cameras typically provide a display element, such as a liquid crystal display (LCD) or Optical Light-Emitting Device (OLED) component that allows the photographer to use the camera more effectively. For example, the display element can show a view of the last image obtained or of other previously stored images or may present an arrangement of menus, messages, command buttons, or other operational aids for the photographer.

Continuing advancements and improvements in digital imaging have increased the overall capability of the digital camera, along with its operational complexity. Among the enhanced capabilities of digital image capture devices is the ability to obtain images of more than one type, such as to obtain both motion picture images and still images. To facilitate viewing, U.S. Pat. No. 7,145,601 entitled “Multi-Modal Reproducing Apparatus and Digital Camera” issued to Misawa et al. describes an index print screen layout that enables the photographer to select either a still image or a motion image for viewing. Split-screen solutions that support these capabilities for showing multiple image types are described, for example, in U.S. Pat. No. 7,057,658 entitled “Digital Camera Capable of Forming a Smaller Motion Image Frame” issued to Shioji et al. In Shioji, a reduced size motion image is shown within a portion of a larger display. U.S. Patent Application No. 2003/0160892 entitled “Camera Having Flexible Display” by Tamura describes a single, flexible display provided with a camera, wherein the display can be segmented into separate display sections.

To respond to the need for improved and adaptable operator interface controls, the use of additional display components has been proposed. For example, commonly assigned U.S. Patent Application No. 2004/0051804 entitled “Mutual Display Support for a Digital Information/Imaging System” by Veturino et al. discloses a digital camera having two display elements. A first display element is used for image display, as with other conventional digital cameras. A second display element, smaller than the first, is used to provide status information and operational controls. U.S. Pat. No. 6,812,967 entitled “Digital Camera Having Multiple Displays” to Niikawa et al. describes a camera equipped with both an LCD and an Electronic View Finder (EVF) for achieving improved focus.

Dual display elements have been employed to expand display capabilities in a few types of portable electronic devices. For example, U.S. Patent Application No. 2004/0014488 entitled “Foldable Cellular Telephone” by Sawayama et al. describes a hand-held portable phone device having separate displays, enabled or disabled appropriately according to the folded or open state of the device. For this type of device, either one display or the other can be enabled at a time, depending on how the device is being used. Another handheld apparatus with two displays is described in U.S. Patent Application No. 2006/0183505 entitled “Digital Mobile Planner” by Willrich. For this type of Personal Digital Assistant (PDA), having two displays can provide features such as additional control functions, enlarged image display area, or separate areas for each of two or more peripheral image capture devices, for example.

While hand-held computing and imaging devices with more than a single display element have been proposed, however, the operator display solutions presented still fall short of meeting a number of needs of today's digital camera photographers. For example, segmentation of a display for showing smaller windows of various types of images within larger images, such as those described in the '658 Shioji et al. disclosure, may allow two types of images to be viewed simultaneously, but provides a cluttered arrangement that can be difficult to view and use. This is particularly true where a motion image is available. It would be advantageous to provide the motion image in as large a format as possible, rather than to compromise on window size in order to fit both still and motion pictures together. Dual-display solutions that may be acceptable for a hand-held PDA that is used to record and display information and obtain operator input, such as those described in the '505 Willrich disclosure, are not readily adaptable for a digital camera. This is because the display components of the hand-held PDA must share space with operator controls and viewfinder, and the required system optics constrain display size, accessibility for handling and viewing, and position.

Still other needs relate to the characteristics of the images obtained and their possible arrangement. Because many types of digital cameras are capable of obtaining panoramic view images whose horizontal dimensions can be twice or more that of their height dimension, a suitable display solution for the panoramic view is still needed. A particular problem with smaller cameras relates to display area available; the display is constrained in size along the rear of the camera and competes for space with controls, viewfinder, and other necessary components.

It would be advantageous to display “thumbnail views” of stored images and video sequences in a way that allows the operator to step through and display the stored images while being aware of the full image sequence. Photographers also want the opportunity to arrange sets of images on a single page, a capability that is difficult to use with a single camera display screen. Moreover, any solution for using multiple display components with a camera must provide some method for coordinating their cooperation, optimizing usefulness to the operator.

### SUMMARY OF THE INVENTION

In general terms, the present disclosure relates to photography and photographic equipment and more particularly relates to a digital camera that provides a combined display area formed by two or more image displays.

One aspect of the present invention is directed to a digital camera. The digital camera includes a first image display formed on the surface of the camera body, a second image display mounted to the camera body and deployable to at least one viewing position in which the first and second image displays provide a combined display area.

Another aspect of the present invention is directed to a digital camera. The digital camera including a first image display formed on the surface of the camera body, a second image display mounted to the camera body and deployable to at least one viewing position, wherein one of said first and second displays provides a motion preview image for composing images to be captured and wherein the other of first and second image displays provides a previously captured still image.

Another aspect of the present invention is directed to a digital camera. The digital camera including an image display formed on the surface of the camera body, wherein the image display comprises a first display area displaying a motion preview image for composing images to be captured and a second display area displaying a previously captured still image.

Another aspect of the present invention is directed to a method for displaying images. The method including providing an imaging device having first and second image displays wherein the second display is deployable to allow a view of a variable portion of the first display, and displaying an image in the viewing area comprising the second image display and the viewable portion of the first display.

Another aspect of the present invention is directed to a method for displaying imaging. The method including providing a camera with a combined display area formed by a first image display adjacent to a second image display, and displaying an image that extends over at least portions of the combined display area.

Another aspect of the present invention is directed to a method of displaying images. The method including providing a camera with first and second image displays, displaying on said first image display a digital template for forming an image product, wherein the digital template has at least one area for placement of a captured digital content, and displaying on said second image display the captured digital content.

Another aspect of the present invention is directed to a method of displaying images. The method including providing a camera with first and second image displays, displaying on said first image display a first page of a multiple page digital template for forming an image product, wherein the multiple page digital template has at least one area for placement of a captured digital content; and displaying on said second image display a subsequent page of the multiple page digital template.

Another aspect of the present invention is directed to a digital camera. The digital camera including an image display formed on the surface of the camera body, wherein a portion of the image display includes a preview display area for displaying a motion preview image for composing images to be captured, and a user interface for controlling the portion of the image display used as the preview display area.

### BRIEF DESCRIPTION OF THE DRAWINGS

The invention may be more completely understood by considering the detailed description of various embodiments of the invention which follows in connection with the accompanying drawings. Referring now to the drawings in which like reference numbers represent corresponding parts throughout:

FIG. 1 is a plan view of a camera having dual displays horizontally arranged according to one embodiment;

FIG. 2 is a plan view of a camera having dual displays vertically arranged;

FIGS. 3A, 3B and 3C illustrate another plan view of a digital camera having first and second displays in which the second display slides over he first display;

FIG. 4 illustrates one embodiment where on-screen menus are displayed in the combined display area;

FIGS. 5A and 5B are embodiments of multiple displays having multiple images;

FIG. 6 is and alternate embodiment of multiple displays having multiple images;

FIG. 7 illustrates a second display that is separable from camera body;

FIG. 8 illustrates the use of a stylus for manipulating images on the first and second displays;

FIG. 9 illustrates multiple displays having a template for creating an image product;

FIG. 10 illustrates on-screen operator controls enabling the operator to scroll through successive images on display for the selection process;

FIGS. 11A, 11B, and 11C illustrate alternate embodiments in which a second and third display is provided for a digital camera;

FIGS. 12A, 12B, 12C, and 12D illustrate the various configurations of the displays and the use of each display for presenting a live view of a scene;

FIG. 13 illustrates the partitioning of a display into distinct regions;

FIG. 14 is an embodiment of a digital camera that uses a container to display video content; and

FIG. 15 is a block diagram illustrating a simplified schematic of the basic components of a digital camera having a second display.

### DETAILED DESCRIPTION OF THE INVENTION

Various embodiments of the present description will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The embodiments of the present invention employ two or more displays as part of a digital camera and make possible a number of advanced capabilities that enhance the experience and toolset of the photographer.

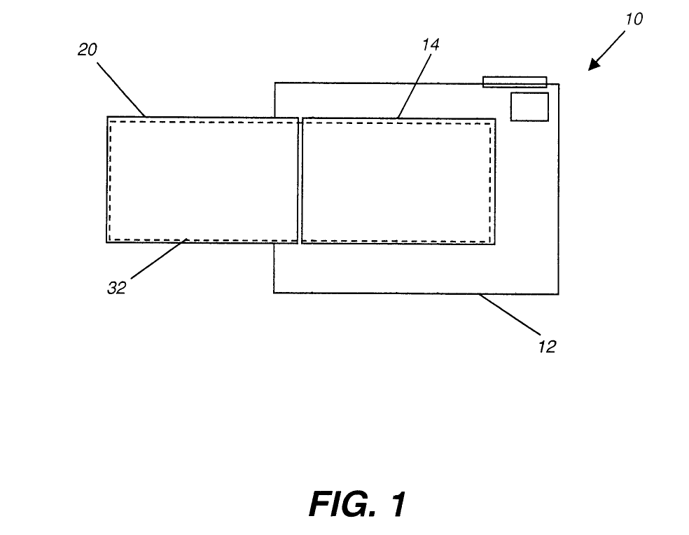

FIG. 1 is a plan view of a digital camera 10 having first and second displays 14 and 20 horizontally arranged to provide a combined display area 32 according to one embodiment. The combined display area 32 is formed by the two or more displays 14, 20 as illustrated by the dashed outline shown in FIG. 1. Accordingly, in one embodiment, the combined display area 32 can span all or part of the two or more displays 14, 20.

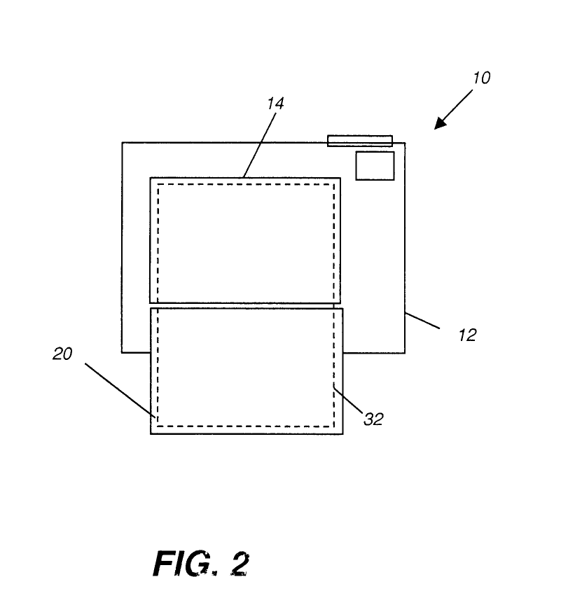

The second display 20 is retractably mounted to a camera body 12 by a foldable-hinged arrangement, allowing digital camera 10 to remain compact for handling and storage. First and second displays 14 and 20 may be oriented horizontally with respect to each other, as shown in FIG. 1, or vertically to form combined display area 32 as shown in the embodiment of FIG. 2. A foldable-hinged arrangement helps to protect both display 14 and 20 surfaces during handling or carrying of the digital camera 10.

Unlike earlier dual-display solutions, the embodiments of the present embodiment provide second display 20 as capable of full image display, similar to the capability available for first display 14. This configuration makes possible a range of versatile new camera features and makes them easy to use, in ways not available using conventional camera display solutions, as will be described in more detail. In one embodiment, the first and second displays 14 and 20 are both color LCD components, so that they present a similar appearance when displaying sequential portions of the same image. Alternately, different types of display components could be used, in which both displays 14 and 20 are capable of displaying an image. Either or both display 14 or 20 could include touch screen capability.

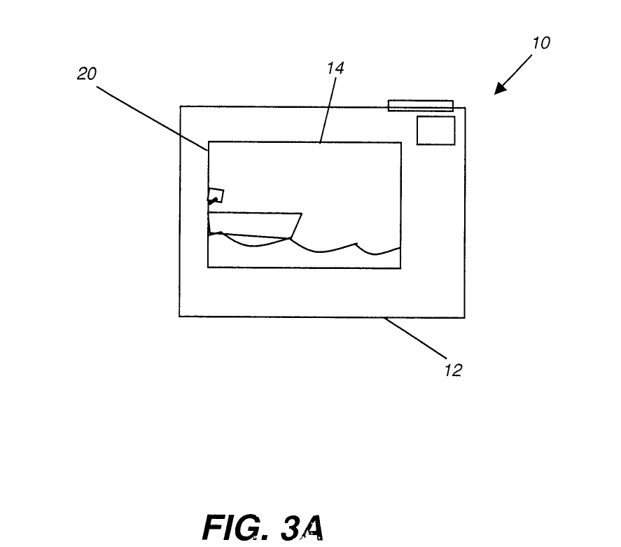

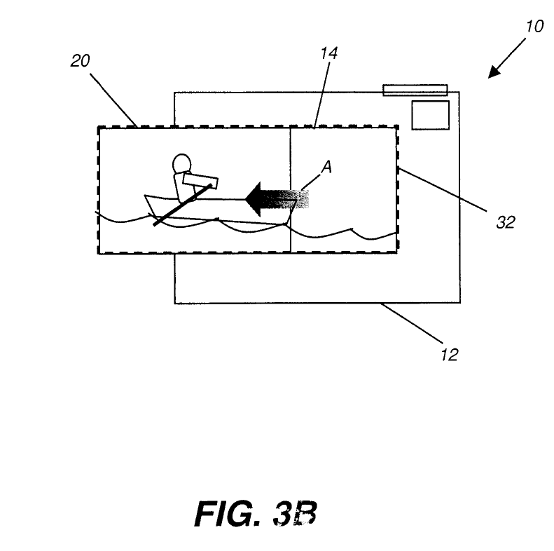

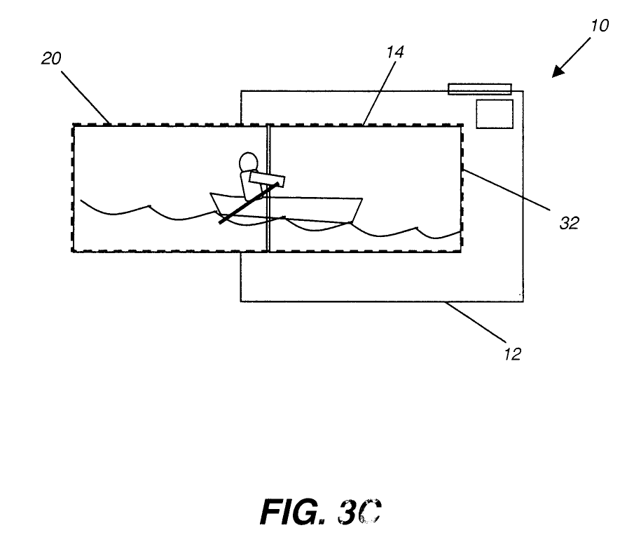

FIGS. 3A, 3B and 3C illustrate another plan view of a digital camera 10 having first and second displays 14 and 20 in which the second display 20 slides over the first display 14. FIG. 3A is one embodiment of how the first and second displays 14 and 20 are arranged to be overlaid for storage or compact handling, but second display 20 optionally slides over and out from atop first display 14. FIG. 3B is another embodiment in which second display 20 slides out in a direction A. Here, the combined display area 32 is defined as the display area formed by second display 20 plus the visible portion of underlying first display 14. As shown in FIG. 3C, the maximum combined display area 32 available is the sum of both visible image areas. With a slidable arrangement, automatic sizing of combined display area 32 can be obtained by having the camera control the movement of second display 20 based on image size.

One problem with conventional display solutions, as noted earlier, relates to the aspect ratio of the camera display, which can be disadvantaged for display of a panoramic image. As shown in FIG. 3C, second display 20 can be used in conjunction with first display 14 to extend the dimensions of combined display area 32 so that panoramic views can be obtained.

In similar manner, using the vertical arrangement of FIG. 2, combined display area 32 can be expanded in height. This would allow a variable image display size, a feature not available with conventional cameras. Thus, the operator can specify a preferred display size for an image, so that combined display area 32 includes adjacent areas of both first and second displays 14 and 20. Having a larger area than might be needed for image display also offers advantages where on-screen command buttons, operator menus, or other command entry utilities can share the display area.

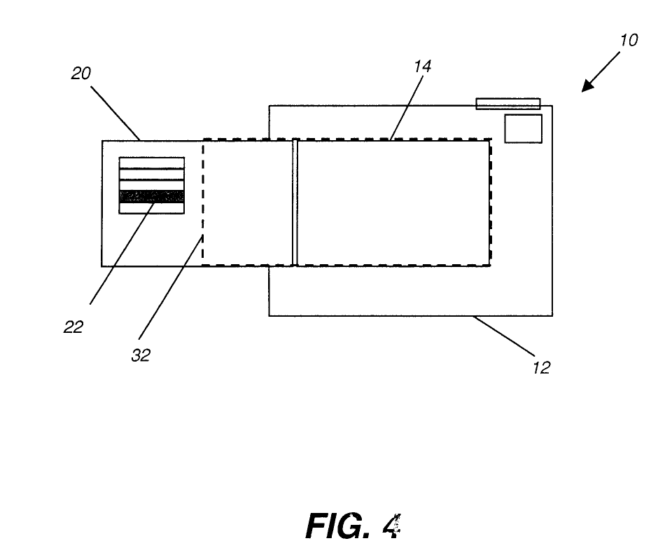

FIG. 4 illustrates one embodiment where on-screen menus are displayed in the combined display area 32. In FIG. 4, there is shown a panoramic view arrangement in which menu entries 22 are presented to the photographer in the second display 20. In a touch-screen embodiment, the photographer can reposition menu entries 22, or other command buttons, using their fingertip or a stylus.

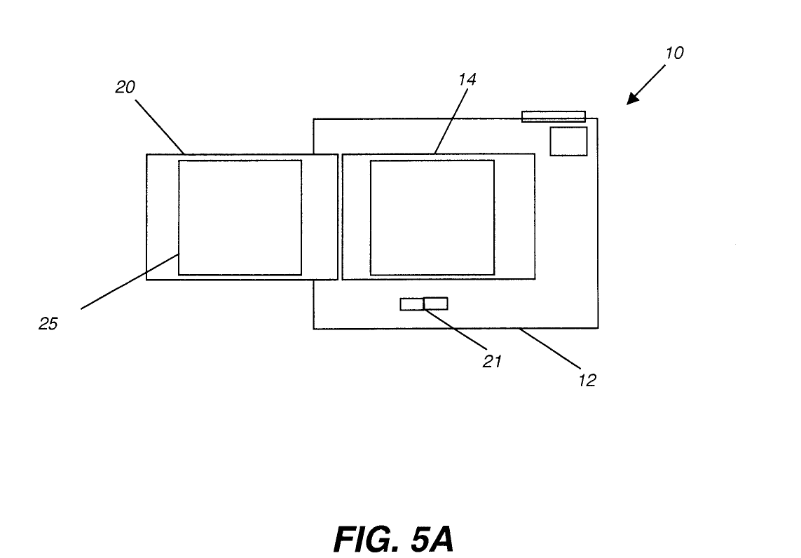

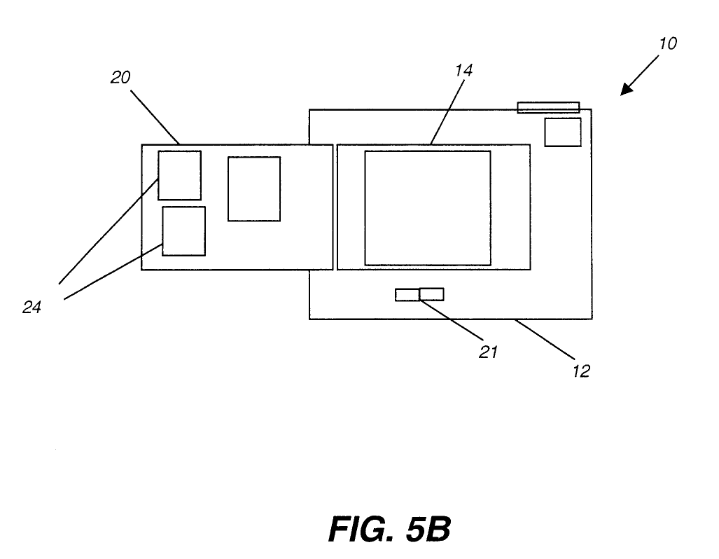

FIGS. 5A and 5B are embodiments of multiple displays having multiple images. When equipped with first and second displays 14 and 20, each display can be used to show a different image. In addition to showing a single image concurrently on both image displays, different images and types of images can be shown on different displays. Thus, for example, in FIG. 5A, the last still image 25 captured and stored can be displayed on second display 20 while live video 27 displays on first display 14. In this manner, digital camera 10 can continue to capture images without the need for the user to switch between review mode and capture mode. This is an advantage over conventional single-display digital camera designs that may offer both review and capture modes, but require the entry of a command in order to switch between modes. For example, switching between these two modes typically requires the use of a button, switch, or programmed soft display button.

FIG. 5B illustrates video keyframes as a set of thumbnail still images. In FIG. 5B, the set of thumbnail still images can be displayed on second display 20 where the thumbnail still images in this set represent still images of major scene changes in a video image stream using a technique known as video keyframe extraction. An example of video keyframe extraction is found in commonly assigned U.S. Patent Application Publication No. 2003/0058268 entitled “Video Structuring By Probabilistic Merging Of Video Segments” by Loui et. al., incorporated here by reference in its entirety.

In another embodiment, FIG. 5B can illustrate an arrangement of thumbnail images 24 on second display 20 and first display 14 in a storybook application having images on a pair of sequential pages using stored images. Control buttons 21 allow the user to advance in the arranging or viewing of subsequent pages. If one or both displays use touch screen technology, the user can move these thumbnail images around on a page with a stylus to create the best aesthetic layout. Using the same tool, the user can also change the size of the images on the page. The user can use this feature for the purposes of creating/viewing a series of sequential scrapbook pages, photobook pages, or configure/view any other type of photoproduct requiring multiple images.

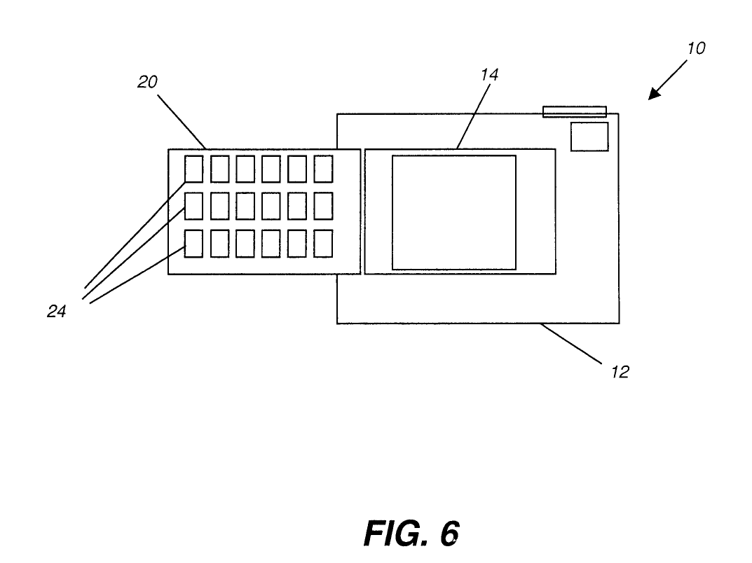

FIG. 6 is an alternate embodiment of multiple displays having multiple images. In FIG. 6, a second display 20 is optionally configurable for use in index display. Accordingly, a set of thumbnail images 24 is shown on second display 20. Touch screen or other pointing methods can then be used to show an enlarged view of a selected thumbnail image on first display 14.

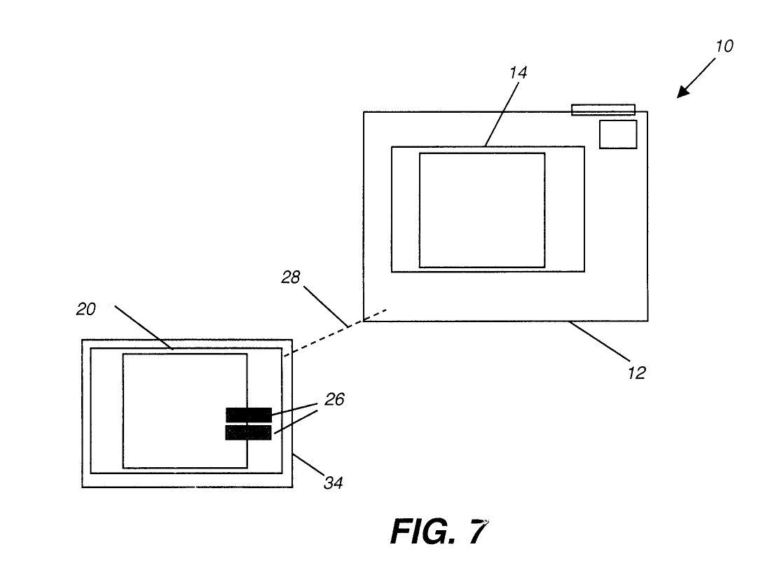

FIG. 7 illustrates a second display 20 that is separable from camera body 12. In FIG. 7, a connection for transfer of data to and from display 20 can be through, but not limited to, a wireless connection 28 as shown by a dashed line in FIG. 6 or can be hard-wired. For a wireless connection, battery power or some other power source must be provided for second display 20. In one embodiment, second display 20 can be snapped or otherwise fitted into place alongside first display 14, as shown in FIGS. 1 and 2, so that data communication and source power are provided along with the mechanical connection. Then, second display 20 can be removed for remote use, as will be described in more detail subsequently. As with other embodiments, either or both displays 14 and 20 can be used for still or motion images.

An optional function for a remote embodiment allows second display 20 to be used to provide a measure of remote control for digital camera 10 operation. For example, as shown in FIG. 7, operator controls 26 could be provided on a touch screen that serves as second display 20 and is in a housing 34 that is detachable from the digital camera 10. In this detachable state, second display 20 can be used as a standalone image display device displaying images (still or video) that are stored within the display.

FIG. 8 illustrates the use of a stylus for manipulating images on the first and second displays. As shown in FIG. 8, a stylus 30 can be used to make written annotation for recording on an image or an album page. Stylus 30 could be a pencil, pen, or other object having the necessary size for providing pointing action. Finger contact could also serve as a stylus.

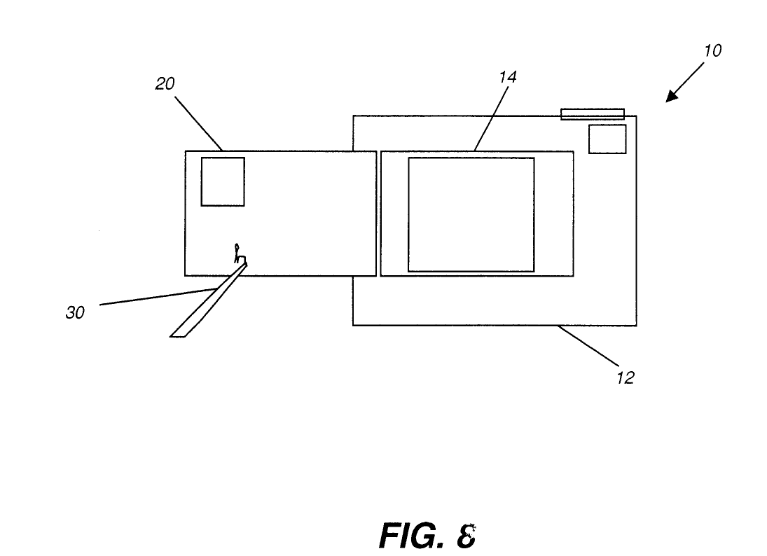

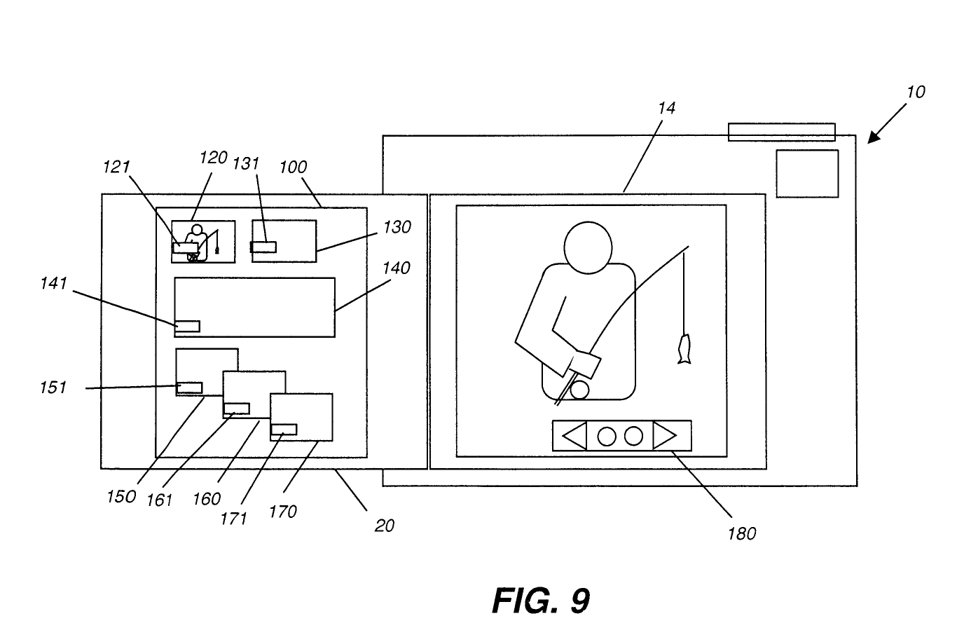

FIG. 9 illustrates multiple displays having a template for creating an image product. In one embodiment, a digital camera 10 with displays 14 and 20 can be provided with a template for creating an image product, using setup software such as that described in commonly assigned U.S. Pat. No. 7,092,966 entitled “Method Software for Creating an Image Product Having Predefined Criteria” to McIntyre, incorporated herein by reference in its entirety. With the added advantage of dual displays 14 and 20, some or all of the procedures for creating an image product can now be performed directly on digital camera 10 itself, rather than requiring a separate computer workstation, as is described in U.S. Pat. No. 7,092,966.

In FIG. 9, a template 100, downloaded from a host computer or from a network host computer can be stored and displayed on display 20. Containers 120, 130, 140, 150, 160, and 170 from template 100 can be displayed in thumbnail form on display 20. One or more tags 121, 131, 141, 151, 161, and 171 can be shown in their corresponding containers 120, 130, 140, 150, 160, and 170, where tags 121, 131, 141, 151, 161, and 171 perform the same overall function described in U.S. Pat. No. 7,092,966, providing various metadata about the images to be provided in the containers. The camera operator can then select images stored in the camera, or downloaded from a network or host computer, to fill in corresponding containers 120, 130, 140, 150, 160, and 170 and complete part or all of the setup of the image product. Using the second screen 20, the operator can view and select different images for each of corresponding containers 120, 130, 140, 150, 160, and 170. Motion or still images can be selected, as available from images stored on or otherwise available to digital camera 10.

FIG. 10 illustrates on-screen operator controls 180 enabling the operator to scroll through successive images on display 14 for the selection process. Referring to FIG. 10, metadata selection boxes 182, 184, and 186 can be provided for camera operator selection of appropriate tag data for each image. The newly selected and tagged image from display 14 can then be inserted into template 100 on display 20 (FIG. 9).

In another embodiment, one or more softcopy book products from other devices can be shared and displayed on one of displays 14 and 20. For example, a document downloaded from a portable device such as the Sony® eReader from Sony, Inc. can be displayed, with text content and, optionally, with image content.

Using image album setup capabilities of this embodiment, an electronic album or storybook can be created or modified by the camera operator. Images can be added or updated to personalize an album or storybook product.

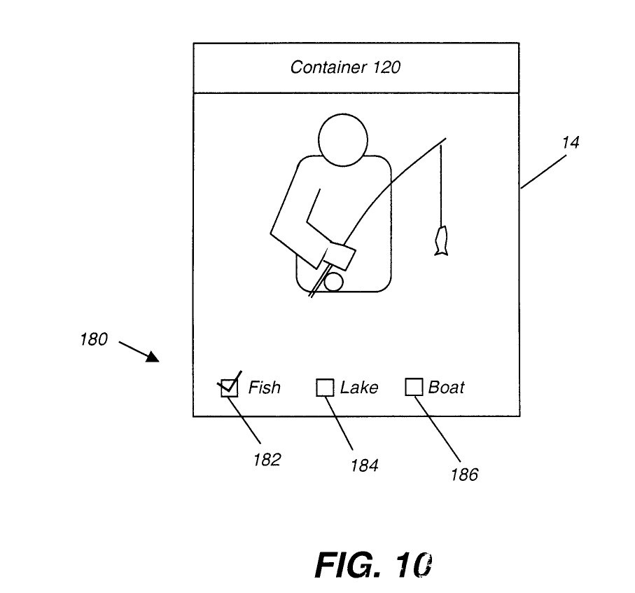

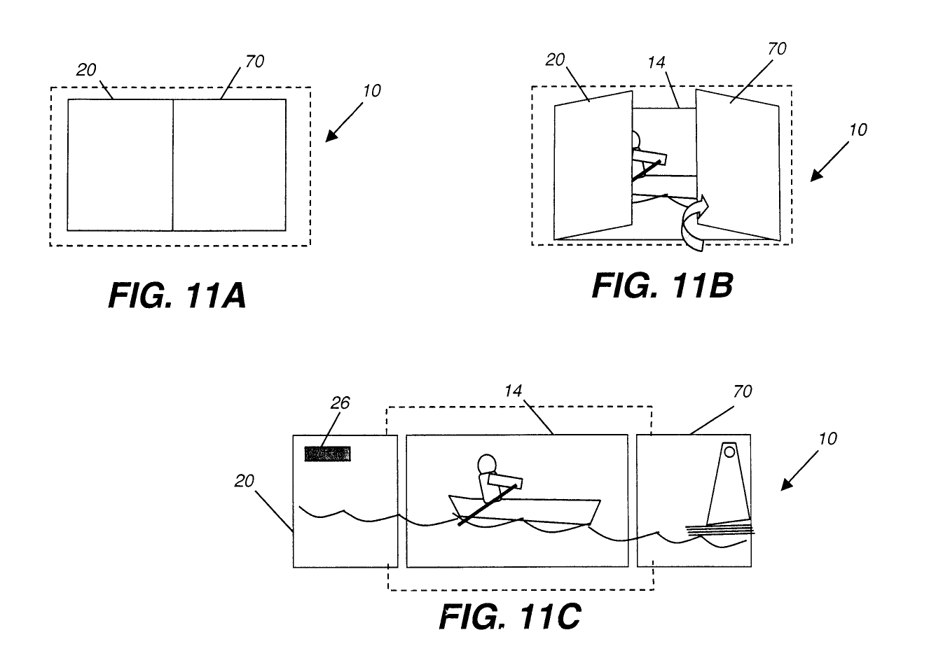

FIGS. 11A, 11B, and 11C illustrate alternate embodiments in which a second display 20 and third display 70 is provided for a digital camera 10. Here, second and third displays 20 and 70 open in window-shutter fashion, enabling an extra-width panoramic view or simply providing more room for operator controls 26. With this arrangement, either or both second and third displays 20 and 70 may alternately be detachable. One or more displays 14, 20, and 70 could be used for still or for motion imaging. Power to either auxiliary display 20 or 70 may remain off until the surface of the display is at least visible to an operator opening the back of digital camera 10 to show these displays. Furthermore, one or both displays 20 and 70 could be used to activate a switch for device power or enablement. Thus, for example, digital camera 10 may be powered on by the user or set into a specific operational mode through the action of opening one or both second and third displays 20 and 70.

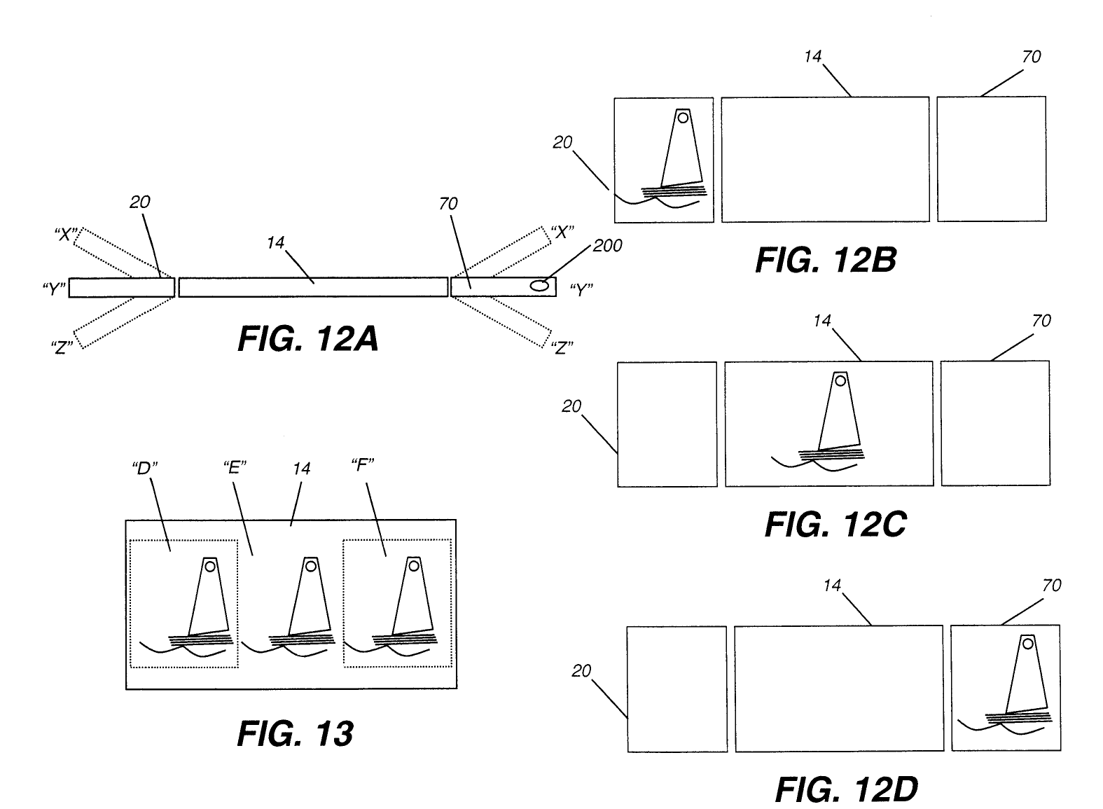

FIGS. 12A, 12B, 12C, and 12D illustrate the various configurations of the displays 14, 20 and 70 and the use of each display for presenting a live view of a scene. When equipped with first, second and third displays 14, 20 and 70, each display can be selectable to display the live view of the scene as captured by the digital camera 10. Control button 200 enables the user to toggle the live view between display 20 as shown in FIG. 12B, display 14 as shown in FIG. 12C, and display 70 as shown in FIG. 12D.

Sequential operation of the control button 200 causes the live view to switch between displays. Such positioning of the live view on the digital camera 10 enables the user to hold the camera at a wide variety of capture positions while still being able to see what is about to be captured. As shown in FIG. 12A, displays 20 and 70 are rotationally mounted to the main camera body containing display 14 and forming stationary positions X, Y, and Z useful for allowing the digital camera 10 to be self-supported and stable. This configuration further assists the user in seeing the live view of the scene from a different angle. In an alternate arrangement, further sequential actuation of button 200 enables the live view to be replicated on all three displays 14, 20, and 70 or any desired display(s).

FIG. 13 illustrates the partitioning of a display into distinct regions. A similar result as shown in FIG. 12A is achieved by partitioning a large display 14 into display regions D, E and F as shown in FIG. 13. Using a similar technique with button 200, a user can cause the live view of the scene to shift to a more convenient region of display 14 that enables better visibility for the user. The display 14 can be flexible to provide a concave or convex image similar to the displays 14, 20 and 70 in FIG. 12A.

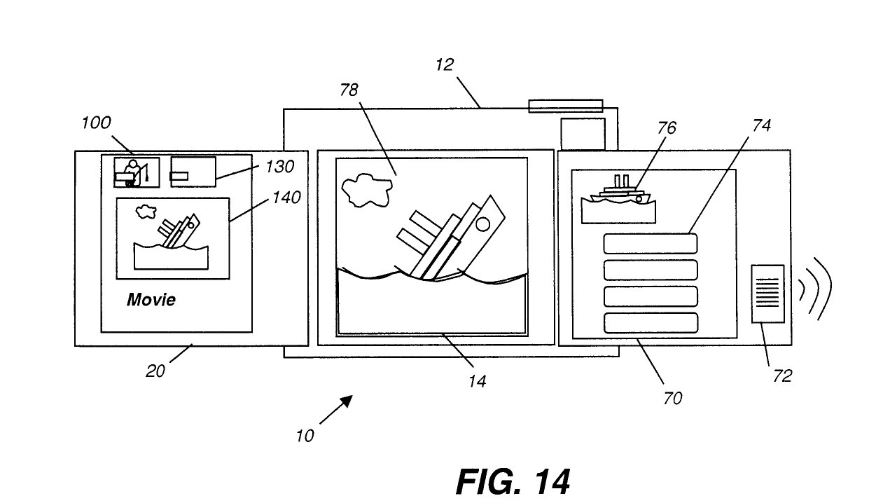

FIG. 14 is an embodiment of a digital camera 10 that uses a container 140 to display video content. In FIG. 14, a digital camera 10 uses a container 140 in a template 100 to display video content as illustrated in FIG. 9. Video content, such as High-Definition (HD) video either obtained from the camera itself or downloaded from a local or networked host computer, or other type of personal content server, is displayed. The digital camera 10 with displays 14 and 20, and optional display 70, can also be used to display video and provide audio content, including soundtrack audio. This enables a wide range of possible uses, allowing digital camera 10 to upload or download video content to a local or networked computer host, for example.

A movie 78 can be displayed on one or more of displays 14, 20, and 70, including display on portions of two or more of these displays. One or more speakers 72 are provided as part of digital camera 10. The one or more speakers 72 can be provided on the same panel with one or both of the displays 20 or 70. Speaker sound direction can be optimized for the viewer by directing the audio signal to each side of the camera. The controls 74 can be provided to control various operations related to video content, including uploading or downloading video, making payment for downloaded video or audio, control of audio volume, control of display brightness, program selection functions, pause, fast forward/reverse, and other functions. The second display 20 may be removable and may provide controls for remote operation of on-camera display 14. Optionally, the video could be displayed on removable display 20, controlled from camera display 14.

The display 70 may also show artwork 76 related to the movie or provide text related to the movie, the soundtrack, or other music lyrics. Video content can be merged into other content similar to using a container within template 100. Thus, template 100 can be a vehicle for organizing and providing a video product for display on the camera or on some other device.

The audio capability allows the digital camera 10 to play music or other audio downloaded from the operator's collection. The collection can be stored on an iPod™, or any other suitable audio storage device. A container in template 100 could also be used for this purpose. Video and audio can also be shared with other devices using real-time wireless transfer, streaming, or some other communications mechanism.

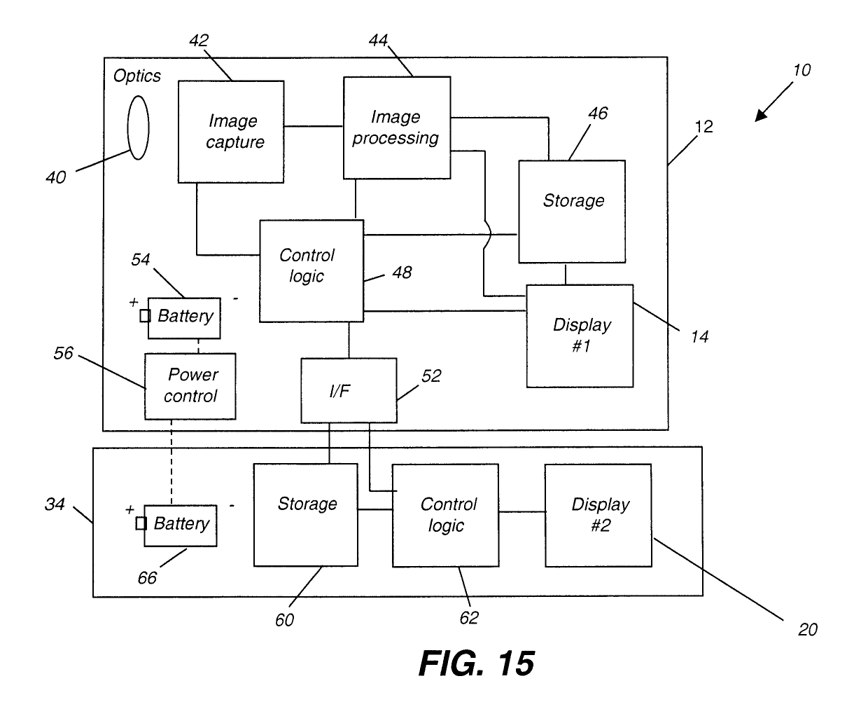

FIG. 15 is a block diagram illustrating a simplified schematic of the basic components of a digital camera 10 having a second display 20. Digital camera 10 has optics 40 and image capture circuitry 42 for obtaining an image. Image processing circuitry 44 then processes the image, which can be sent to storage 46 or to a first display 14. A control logic processor 48 monitors and controls the image capture, storage, and display sequence. An interface 52 allows connection with peripheral display having a housing 34 including second display 20. However, the invention is not limited to a single housing 34 including second display 20 and any number of additional housings and displays can be used. In the embodiment shown, housing 34 is more than simply a peripheral display output device of digital camera 10. Housing 34 includes the second display 20 and can additionally have a control logic processor 62 and storage 60. Additionally, housing 34 may optionally have a battery 66. This arrangement would alleviate the load on a battery 54 in digital camera 10. In another embodiment, the second display 20 can include a control logic processor 62, storage 60 and a battery 66.

In one embodiment, batteries 54 and 66 on digital camera 10 and in housing 34 work together to provide power to components in various configurations, as controlled by a power control 56. For example, power control 56 can switch battery 56 into use for second display 20 or housing 34 when the second display 20 or the housing 34 is attached to the main body of digital camera 10. Alternately, power control 56 may switch power to either battery 54 or 66, depending on which of these power sources is more fully charged. The use of optional control logic processor 62 with storage 60 could allow independent operation of second display 20 without impact on the operation of digital camera 10.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention. For example, functions attributed to the second display in the preceding description can be performed by the first display. Displays 14 and 20 can be of different sizes and a number of possible arrangements could be used for coupling second display 20 to the camera. More than two displays can be used, allowing, for example, an extended panoramic view or providing other features.

### Parts List

10 camera
12 body
14 display
20 display
21 control buttons
22 menu entry
24 thumbnail images
25 still image
26 operator control
27 live video
28 wireless connection
30 stylus
32 combined display area
34 housing
40 optics
42 image capture circuitry
44 image processing circuitry
46 storage
48 control logic processor
52 interface
54 battery
56 power control
60 storage
62 control logic processor
66 battery
70 display
72 speaker
74 control
76 artwork
78 movie
100 template
120 container
121 tag
130 container
131 tag
140 container
141 tag
150 container
151 tag
160 container
161 tag
170 container
171 tag
180 control
182 selection box
184 selection box
186 selection box
200 control button
D display region
E display region
F display region
X stationary position
Y stationary position
Z stationary position

1. A digital camera comprising:
a first image display formed on the surface of the camera body;
a second image display mounted to the camera body and deployable to at least one viewing position in which the first and second image displays provide a combined display area.

2. The digital camera of claim 1, wherein the second display is disposed within a detachable housing.

3. The digital camera of claim 2, wherein the second display is in wireless communication with the camera.

4. The digital camera of claim 2, wherein the detachable housing of the second display further comprises a battery.

5. The digital camera of claim 1, wherein at least one of the first or second image displays is a touch screen.

6. The digital camera of claim 1 further comprising a third display mounted to the camera body and deployable to at least one viewing position in which the first, second and third image displays provide a combined display image area.

7. The digital camera of claim 6, wherein the second and third image displays are each contained within a housing.

8. The digital camera of claim 7, further comprising at least one speaker disposed within the housing for each of the second and third image displays.

9. The digital camera of claim 6, wherein each of the second and third image displays are movable to a plurality of different display positions.

10. The digital camera of claim 9, wherein the plurality of different display positions further comprise a concave position.

11. The digital camera of claim 10, wherein the plurality of different display positions further comprise a convex position.

12. The digital camera of claim 1 further comprising at least one speaker for audio output from the camera.

13. The digital camera of claim 12 wherein the at least one speaker is on the body of the second color image display.

14. The digital camera of claim 12 wherein the at least one speaker is on the body of the camera.

15. The digital camera of claim 1 wherein the second image display is contained in a housing hinged to the body of the digital camera.

16. The digital camera of claim 15, wherein the housing of the second image display is movable to a plurality of different display positions.

17. The digital camera of claim 1, wherein the second image display is retractably mounted to the body of the digital camera.

18. The digital camera of claim 17, wherein the second image display is deployable to a plurality of different positions corresponding to a plurality of combined display image area having a plurality of different aspect ratios.

19. The digital camera of claim 1, wherein the second display is disposed within a detachable housing comprising at least one speaker for audio output from the camera.

20. The digital camera of claim 1, wherein the second image display is disposed within a detachable housing comprising a remote control for operation of the digital camera.

21. The digital camera of claim 20 further comprising a wireless communication interface between the second image display and the digital camera.

22. A method of displaying imaging comprising:
providing a camera with a combined display area formed by a first image display adjacent to a second image display;
displaying an image that extends over at least portions of the combined display area.

23. The method of claim 22, wherein the combined display area further comprises at least a portion of a third display that is disposed adjacent to the first display.

24. A digital camera comprising:
an image display formed on the surface of the camera body, wherein a portion of the image display includes a preview display area for displaying a motion preview image for composing images to be captured;
a user interface for controlling the portion of the image display used as the preview display area.
